(19) United States
(12) Patent Application Publication
(10) Pub. No.: US 2025/0226684 A1
(43) Pub. Date: Jul. 10, 2025

(54) IN-VEHICLE CHARGER

(71) Applicant: TOYOTA JIDOSHA KABUSHIKI KAISHA, Toyota-shi (JP)

(72) Inventor: Taiga DOI, Okazaki-shi (JP)

(73) Assignee: TOYOTA JIDOSHA KABUSHIKI KAISHA, Toyota-shi (JP)

(21) Appl. No.: 18/983,847

(22) Filed: Dec. 17, 2024

(30) Foreign Application Priority Data
Jan. 4, 2024 (JP) 2024-000347

(51) Int. Cl. H02J 7/00; B60L 53/22

(52) U.S. Cl. CPC H02J 7/007188; B60L 53/22

(57) ABSTRACT

The present disclosure relates to an in-vehicle charger capable of reducing the influence of electromagnetic waves on an external environment. The in-vehicle charger is disposed in an engine compartment. The in-vehicle charger includes a first charger and a second charger. The second charger is disposed closer to a hood than the first charger.

### CROSS-REFERENCE TO RELATED APPLICATION

This application claims priority to Japanese Patent Application No. 2024-000347 filed on Jan. 4, 2024, incorporated herein by reference in its entirety.

### BACKGROUND

### 1. Technical Field

The present disclosure relates to an in-vehicle charger.

### 2. Description of Related Art

Japanese Unexamined Patent Application Publication No. 2010-207054 (JP 2010-207054 A) discloses a technique for reducing electromagnetic waves (noise) applied to vehicle accessories by a converter in an engine compartment.

### SUMMARY

In the technique disclosed in JP 2010-207054 A, only the influence of electromagnetic waves in the engine compartment is taken into consideration. Therefore, in such a case where, for example, the hood of the engine compartment is opened, the electromagnetic waves emitted from the charger may influence an external environment.

The present disclosure has been made in view of the above, and an object thereof is to provide an in-vehicle charger capable of reducing the influence of electromagnetic waves on the external environment.

An in-vehicle charger according to the present disclosure, disposed in an engine compartment, includes:
a first charger; and
a second charger disposed closer to a hood than the first charger.

According to the present disclosure, since the charger is disposed in two stages, the electromagnetic waves emitted from a lower charger can be distanced from the hood, which makes it possible to reduce the influence of the electromagnetic waves on the external environment.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an example of a configuration of a vehicle including an in-vehicle charger according to an embodiment;

FIG. 2 is a schematic diagram illustrating an example of a configuration of a first charger and a second charger in the in-vehicle charger according to the embodiment;

FIG. 3 is a time chart in a case where the output electric power of the second charger is limited when the hood is opened in the in-vehicle charger according to the embodiment;

FIG. 4 is a time chart when the output electric power of the first charger and the output electric power of the second charger are limited when the hood is opened in the in-vehicle charger according to the embodiment; and

FIG. 5 is a flowchart illustrating a flow of a charging control method executed by the in-vehicle charger according to the embodiment.

### DETAILED DESCRIPTION OF EMBODIMENTS

An in-vehicle charger according to an embodiment of the present disclosure will be described with reference to the drawings. Incidentally, the constituent elements in the following embodiments include those that can be easily replaced by a person skilled in the art or those that are substantially the same.

### In-Vehicle Charger

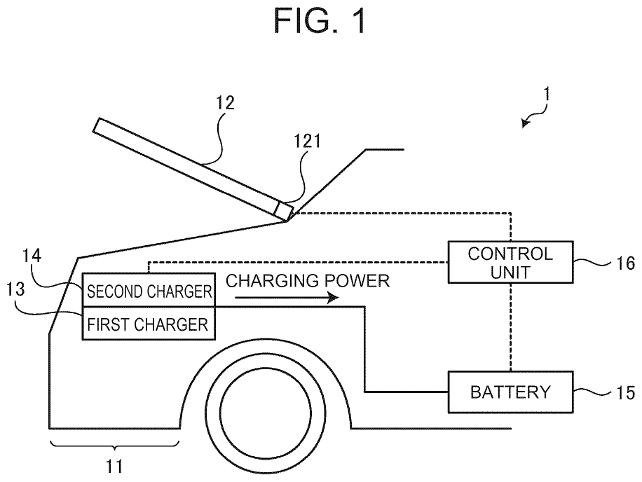

A configuration of an in-vehicle charger according to the embodiment will be described with reference to FIGS. 1 to 4. The in-vehicle charger according to the embodiment is mounted on, for example, hybrid electric vehicle (HEV), plug-in hybrid electric vehicle (PHEV), battery electric vehicle (BEV), or the like.

As illustrated in FIG. 1, a vehicle 1 including an in-vehicle charger according to an embodiment includes an engine compartment 11, a hood 12, a first charger 13, a second charger 14, a battery 15, and a control unit 16. Note that, in the figure, only the configuration essential to the in-vehicle charger according to the embodiment is illustrated in the configuration of the vehicle 1, and the other configurations are not illustrated in the figure.

The engine compartment 11 houses a first charger 13 and a second charger 14. A hood 12 is attached to an upper portion of the engine compartment 11. A hood opening/closing sensor 121 for detecting opening/closing of the hood 12 is attached to the hood 12. Note that the mounting position of the hood opening/closing sensor 121 illustrated in FIG. 1 is an example, and may be mounted at a position different from that in FIG. 1.

The first charger 13 is for supplying electric power supplied from a charging adapter provided in an external charging station to the battery 15. The first charger 13 is provided with a charging circuit (power output circuit).

The second charger 14 is for supplying electric power supplied from a charging adapter provided in an external charging station to the battery 15. The second charger 14 is provided with a charging circuit (power output circuit).

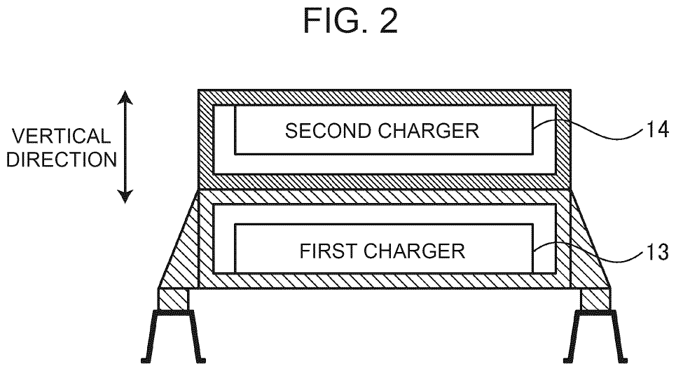

As shown in FIG. 2, the first charger 13 and the second charger 14 are arranged in two stages in the vertical direction (the height direction of the vehicle 1) in the engine compartment 11. That is, the second charger 14 is disposed closer to the hood 12 side (upper side) than the first charger 13.

Further, in a predetermined direction, that is, in a vertical direction, at least a part of the housing surface of the first charger 13 is arranged so as to overlap with the housing surface of the second charger 14. That is, the first charger 13 and the second charger 14 are arranged such that a portion of the first charger 13 and the second charger 14 overlap each other when viewed from above (when viewed from above). As described above, the first charger 13 and the second charger 14 partially overlap each other, so that the second charger 14 on the upper side (the hood 12 side) can shield the electromagnetic wave radiated from the first charger 13 on the lower side. Therefore, the influence of the electromagnetic wave on the external environment can be reduced.

The battery 15 is, for example, a lithium ion secondary battery in which a plurality of battery cells is stacked. The battery 15 is supplied with electric power from the first charger 13 and the second charger 14.

The control unit 16 is realized by a processor including, for example, a Central Processing Unit (CPU), and a memory (main storage unit) including, for example, a Random Access Memory (RAM) and a Read Only Memory (ROM).

The control unit 16 limits the electric power (hereinafter, referred to as “output electric power” or “charging electric power”) output from the first charger 13 and the second charger 14 to the battery 15 as necessary. Specifically, the control unit 16 limits the output electric power to the second charger 14 or the output electric power to the first charger 13 and the second charger 14 in accordance with the open/close state of the hood 12 detected by the hood opening/closing sensor 121.

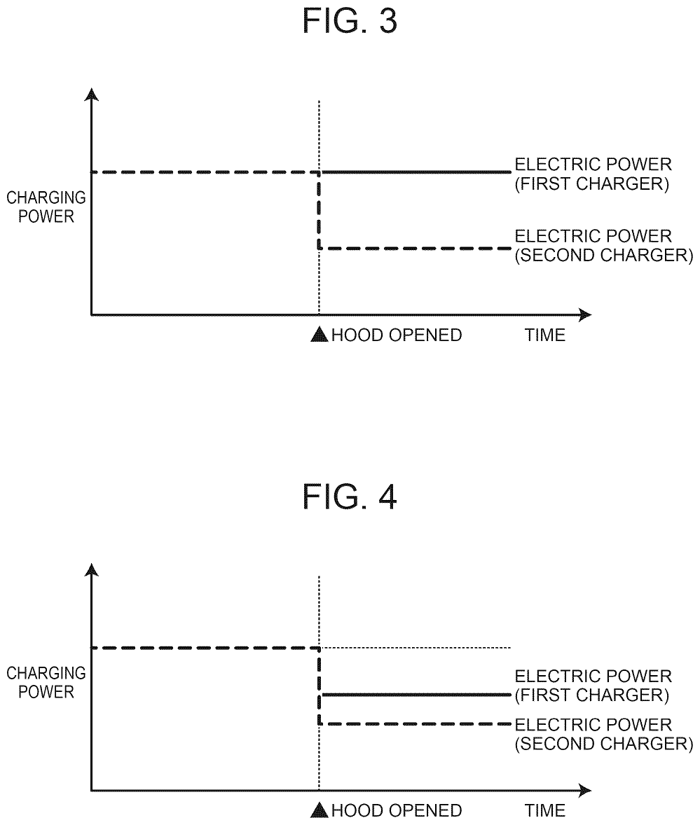

For example, when the hood opening/closing sensor 121 detects that the hood 12 is in the open state, the control unit 16 controls the output electric power of the second charger 14 to be smaller than the output electric power of the first charger 13. In this case, for example, as illustrated in FIG. 3, the control unit 16 does not limit the charging power of the first charger 13 and limits the charging power of the second charger 14. Note that “not limiting the charging power” indicates that the battery 15 is charged with the maximum power that the first charger 13 and the second charger 14 can output, for example. “Limiting the charging power” indicates that the battery 15 is charged with less than the maximum power that the first charger 13 and the second charger 14 can output, for example.

In this way, when the hood 12 is opened, the output electric power of the second charger 14 close to the hood 12 is lowered, so that the electromagnetic wave radiated from the second charger 14 is reduced, so that the influence of the electromagnetic wave on the external environment can be reduced. In addition, by automatically detecting the opening and closing of the hood 12 and performing the power limitation, the generation of the electromagnetic wave can be effectively suppressed when the hood 12 is opened, so that the influence of the electromagnetic wave on the external environment can be reduced.

That is, when charging is performed in a state in which the hood 12 of the engine compartment 11 is opened, there is a possibility that an electromagnetic wave is radiated to the outside. It is the upper side (second charger 14) of the charging circuit arranged in the upper and lower two stages that the contribution rate of the electromagnetic wave to the radiation is high. Therefore, in the in-vehicle charger according to the embodiment, the charging power of the second charger 14 disposed on the upper side among the first charger 13 and the second charger 14 is limited.

On the other hand, the lower side (the first charger 13) of the charging circuits arranged in the upper and lower two stages has a low degree of contribution to the radiation of the electromagnetic wave. Therefore, in the in-vehicle charger according to the embodiment, the charging power of the first charger 13 disposed on the lower side of the first charger 13 and the second charger 14 is not limited. Accordingly, since a large amount of power can be output from the first charger 13 to the battery 15, the charging power of the second charger 14 can be limited, and thus the charging time can be suppressed from becoming long.

In addition, for example, when the hood opening/closing sensor 121 detects that the hood 12 is in the open state, the control unit 16 may limit the charging power of the first charger 13 and the second charger 14 together, for example, as illustrated in FIG. 4. Thus, the influence of the electromagnetic wave on the external environment can be reduced.

### Charging Control Method

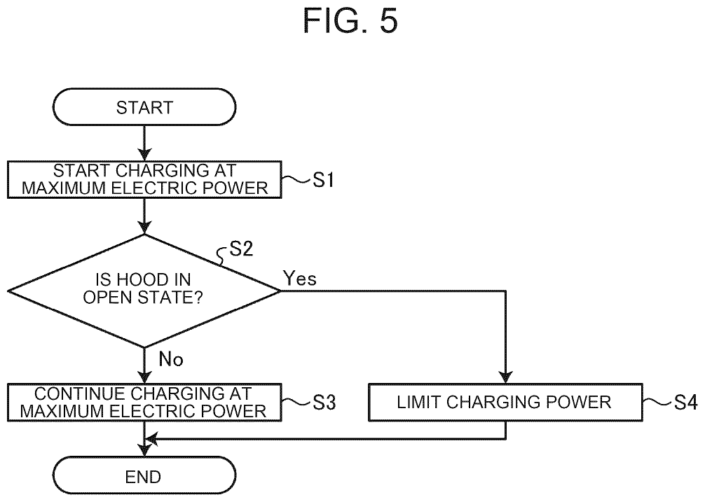

A flow of a charging control method executed by the in-vehicle charger according to the embodiment will be described with reference to FIG. 5.

First, the control unit 16 charges the battery 15 with a predetermined maximum power by the first charger 13 and the second charger 14 (S1). Subsequently, the control unit 16 determines whether or not the hood 12 is open through the hood opening/closing sensor 121 (S2).

If it is determined in S2 that the hood 12 is not in the open state (No in S2), the control unit 16 limits the charging power to the second charger 14 or limits the charging power to the first charger 13 and the second charger 14 (S3), for example, and completes this process. On the other hand, when it is determined in S2 that the hood 12 is open (Yes in S2), the control unit 16 continues to charge the battery 15 with the highest power (S4), and completes this process.

According to the in-vehicle charger according to the embodiment described above, by arranging the first charger 13 and the second charger 14 in two stages, it is possible to move the electromagnetic wave radiated from the first charger 13 in the lower stage away from the hood 12. Thus, the influence of the electromagnetic wave on the external environment can be reduced.

Here, in the charger mounted in the engine compartment, when charging is performed in a state in which the hood of the engine compartment is opened, there is a possibility that an electromagnetic wave is radiated to the outside. Therefore, in the in-vehicle charger according to the embodiment, when the hood 12 is opened, the output electric power to the second charger 14 or the first charger 13 and the second charger 14 is limited. As a result, it is possible to suppress the electromagnetic wave at the time of charging and to secure the necessary charging power.

Further advantages and variations can be readily derived by those skilled in the art. Thus, the broader aspects of the disclosure are not limited to the specific details and representative embodiments presented and described above. Accordingly, various modifications may be made without departing from the spirit or scope of the general inventive concept as defined by the appended claims and their equivalents.

What is claimed is:

1. An in-vehicle charger disposed in an engine compartment, the in-vehicle charger comprising:
a first charger; and
a second charger disposed closer to a hood than the first charger.

2. The in-vehicle charger according to claim 1, wherein at least a portion of a housing surface of the first charger is disposed so as to overlap with a housing surface of the second charger in a predetermined direction.

3. The in-vehicle charger according to claim 1, further comprising a control unit that controls such that output electric power of the second charger is smaller than output electric power of the first charger.

4. The in-vehicle charger according to claim 3, wherein the control unit
detects an open and close state of the hood, and
limits charging power of the first charger and the second charger when the control unit detects that the hood is in an open state.
